(19) United States
(12) Patent Application Publication
(10) Pub. No.: US 2024/0344622 A1
(43) Pub. Date: Oct. 17, 2024

(54) SYSTEMS AND METHODS FOR FLOW METERING

(71) Applicant: Space Valves LLC, Puyallup, WA (US)

(72) Inventor: Kyle Jeffrey Meeuwsen, Puyallup, WA (US)

(21) Appl. No.: 18/635,470

(22) Filed: Apr. 15, 2024

Related U.S. Application Data
(60) Provisional application No. 63/459,687, filed on Apr. 16, 2023.

(51) Int. Cl. F16K 15/02

(52) U.S. Cl. CPC F16K 15/025

(57) ABSTRACT

A check valve assembly can include a housing including an inlet port, an outlet port, and a flow chamber defined by the housing and fluidly coupling the inlet port to the outlet port, and a poppet assembly movable between a closed position and an open position. The poppet assembly can include a poppet positioned in the flow chamber and can be configured to sealingly engage the housing in the closed position to fluidly disconnect the inlet port from the outlet port, and a flow metering orifice positioned in the flow channel. A biasing member can be operably coupled to the poppet, wherein the biasing member is configured to bias the poppet assembly to the closed position.

### CROSS-REFERENCE TO RELATED APPLICATION

This application claims priority to U.S. Provisional Application No. 63/459,687, entitled “SYSTEMS AND METHODS FOR FLOW METERING,” filed on Apr. 16, 2023. The entire contents of the above-referenced application are hereby incorporated by reference in its entirety for all purposes.

### FIELD

The present disclosure relates generally to check valve assemblies for regulating the flow of an operating fluid such as a liquid or gas, and more particularly to a method and apparatus for metering the flow of a liquid or gas within the check valve in a way that reduces wear on the valve.

### BACKGROUND

A check valve allows a fluid, such as a gas, liquid, or mixture of the two to flow in a single direction while prohibiting flow in the other. Flow opposite of the intended direction is referred to as flow in the backward direction or “backflow”. Check valves come in various forms, including ball, swing, and poppet-style check valve designs. Typically check valves are biased to a closed position by a spring or hinge and permit flow in the intended, or forward direction, when pressure at the inlet exceeds the valve's combined spring force and outlet pressure. This is referred to as the valve's “cracking pressure”. Under certain flow conditions, the forward and rearward pressures can interact to cause the valve to rapidly open and close (“chatter”). Such chatter can damage the check valve by, for example, prematurely wearing the internal components of the valve, such as a poppet, spring, valve seat, etc. Accordingly, a check valve that may mitigate at least a portion of the chatter would be welcome in the technology.

### BRIEF DESCRIPTION

Aspects and advantages of the technology will be set forth in part in the following description, or may be obvious from the description, or may be learned through practice of the technology.

In some aspects, the present subject matter is directed to a check valve assembly that includes a housing comprising an inlet port, an outlet port, and a flow chamber defined by the housing and fluidly coupling the inlet port to the outlet port. A poppet assembly is movable between a closed position and an open position. The poppet assembly includes a poppet positioned in the flow chamber and is configured to scalingly engage the housing in the closed position to fluidly disconnect the inlet port from the outlet port. The poppet defines a flow channel and a flow metering orifice positioned in the flow channel. A biasing member is operably coupled to the poppet. The biasing member is configured to bias the poppet assembly to the closed position.

In some aspects, the present subject matter is directed to a check valve assembly that includes a housing including an inlet port, an outlet port, and a flow chamber defined by the housing and fluidly coupling the inlet port to the outlet port. A poppet assembly is movable between a closed position and an open position. The poppet assembly includes a poppet positioned in the flow chamber and configured to sealingly engage the housing in the closed position to fluidly disconnect the inlet port from the outlet port. The poppet assembly further includes a flow metering orifice positioned in a flow channel. A biasing member is operably coupled to the poppet and is configured to bias the poppet assembly to the closed position.

In some aspects, the present subject matter is directed to a method for operating a check valve assembly. The method includes receiving an operating fluid through an inlet port of a housing. The housing further defines an outlet port. The method also includes placing a poppet in a first position to sealingly engage the housing to prohibit flow of the operating fluid from the outlet port to the inlet port. The poppet defines a flow chamber fluidly coupling the inlet port to the outlet port and a flow metering orifice positioned in the flow chamber. Lastly, the method includes placing the poppet in a second position to disengage from the housing to permit flow of the operating fluid from the inlet port to the outlet port. When the poppet moves between the first position and the second position, an inlet pressure of the operating fluid is decreased as the operating fluid flows through the flow metering orifice to reduce movement of the poppet.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side cross-sectional view of a representative check valve assembly in a closed position in accordance with embodiments of the present technology;

FIG. 2 illustrates a side cross-sectional view of the check valve assembly of FIG. 1 in an open position in accordance with embodiments of the present technology;

FIG. 3 illustrates a side cross-sectional view of the check valve assembly of FIG. 1 during pressurized backflow in accordance with embodiments of the present technology; and

FIG. 4 is a flow diagram of a method for the operation of the check valve assembly in accordance with embodiments of the present technology.

Repeat use of reference characters in the present specification and drawings is intended to represent the same or analogous features or elements of the present technology.

### DETAILED DESCRIPTION

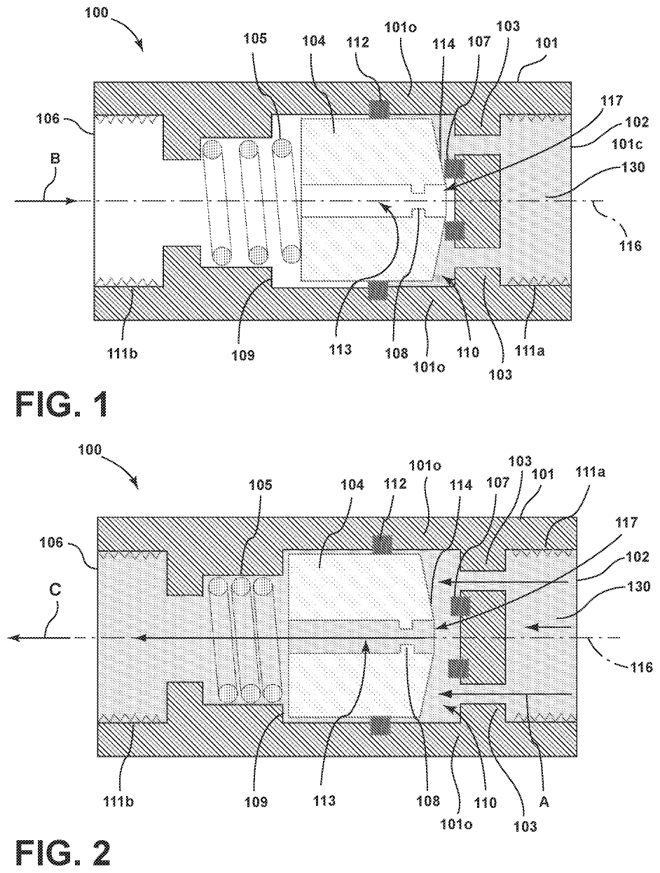

Certain details are set forth in the following description and FIGS. 1-4 to provide a thorough understanding of various embodiments of the present technology. In other instances, well-known structures, materials, operations, and/or systems often associated with check valves, fluid control devices, etc., are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

Reference now will be made in detail to embodiments of the disclosure, one or more examples of which are illustrated in the drawings. Each example is provided by way of explanation of the disclosure, not a limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a signal flows, and “downstream” refers to the direction to which the signal moves.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the disclosed functionality, and any two components capable of being so associated can also be viewed as being “operably couplable” to each other to achieve the disclosed functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a check valve that offers a reduced severity of internal component wear by incorporating a flow metering orifice into the check valve poppet. The flow metering orifice can be a device that creates a flow impediment, which permits a specific flow rate of gas, liquid, or mixture of the two when subject to specific flow conditions.

The check valve can regulate the flow of an operating fluid, such as a liquid and/or gaseous fuel. In multiple embodiments described below, a representative check valve includes a housing and a poppet movably positioned within the housing. More specifically, the housing can include (i) an inlet port configured to receive a flow of the operating fluid, (ii) an outlet port, (iii) a flow chamber fluidly coupling the inlet port to the outlet port, (iv) a poppet, and (v) a biasing member. The poppet can contain a flow metering orifice. In operation, the poppet is movable between a closed position and an open position. In the closed position, the poppet sealingly engages the housing to inhibit the operating fluid from flowing from the inlet port to the outlet port or from the outlet port to the inlet port. In the open position, the poppet does not engage the housing and allows the operating fluid to flow from the inlet port to the outlet port. When the poppet experiences forward flow in the open position, the flow metering orifice inhibits the flow, resulting in a drop in pressure from the inlet side of the poppet to the outlet side of the poppet. This increase in pressure differential across the poppet results in an increase in the force acting on the poppet in opposition to the valve's biasing member. This increase in the force can inhibit or even prevent the check valve assembly from rapidly opening and closing (“chattering”), thereby reducing the wear on the housing, the poppet, and/or other internal components of the check valve assembly. In contrast, conventional check valves are susceptible to chatter when the inlet pressure rapidly fluctuates or the flow is not adequate to actuate the poppet to the fully open position.

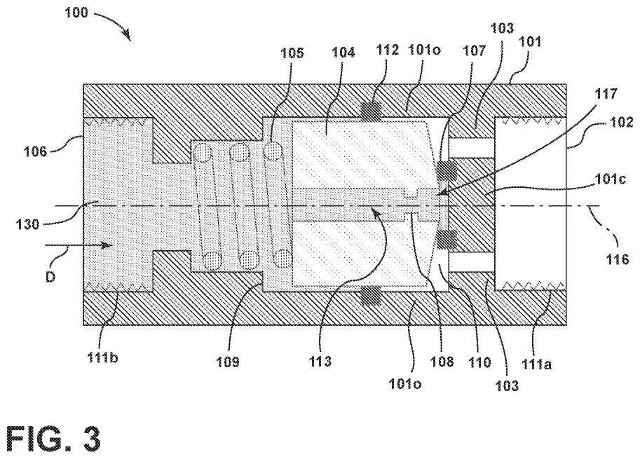

Referring now to FIGS. 1-3, side cross-sectional views of a check valve assembly 100 are illustrated in accordance with embodiments of the present technology. The check valve assembly 100 is in a closed position/configuration in FIG. 1, an open position/configuration in FIG. 2, and a closed position/configuration sealing against backflow in FIG. 3. Referring to FIGS. 1-3 together, the check valve assembly 100 can include a housing 101 and a poppet 104 movably positioned within the housing 101.

In the illustrated embodiments, the housing 101 can define and/or include (i) an inlet port 102 configured to receive a flow of an operating fluid 130, (ii) an outlet port 106, (iii) and a flow chamber 110. The flow chamber 110 fluidly couples the inlet port 102 to the outlet port 106 and, when the check valve assembly 100 is in the open position shown in FIG. 2, routes the operating fluid 130 from the inlet port 102 to the outlet port 106 (e.g., in the direction indicated by the arrow C in FIG. 2). In some embodiments, the operating fluid 130 can be a liquid or gaseous fuel, while in other embodiments, the operating fluid 130 can be water and/or any other liquid, gas, or mixture thereof.

In some embodiments, the housing 101 can include a central section 101c and an outer section 101a. In such instances, the flow chamber may be defined between the central section 101c of the housing 101 and the outer section 1010 of the housing. In some embodiments, the housing may further define a protrusion 115, which may radially align with at least a portion of the central section 101c.

As shown in FIGS. 1-3, the housing 101 can include a first sealing member 107. The first sealing member 107 can be an O-ring, machined seal, and/or another suitable element. In various embodiments, the first sealing member 107 may be downstream of at least a portion of the central section 101c and/or the protrusion 115. Additionally or alternatively, the first sealing member 107 may have a radius that is less than the outer radius of the central section 101c. Additionally or alternatively, the first sealing member 107 may have a radius that is less than the inner radius of the outer section 1010. As used herein, any radius may be measured from an axis 116, centerline, or any other reference line of the check valve assembly 100.

In some embodiments, the inlet port 102 and/or the outlet port 106 can include threads 111 (identified individually as first threads 111a and second threads 111b respectively or other suitable mating features (e.g., grooves, slots, locking channels, etc.) for receiving and securing external components, such as fluid lines, pipes, etc.

The poppet 104 can be movably positioned within the flow chamber 110 and can include a valve seat 114. In some embodiments, the poppet 104 can define a flow channel 113 extending therethrough. The flow channel 113 can have a generally circular, oval, polygonal, or other cross-sectional shape. In other embodiments, the flow channel 113 can be omitted, or the poppet 104 can include a plurality of separate flow channels. In some embodiments, an outer radius of an intake portion 117 of the flow channel 113 may be less than an inner radius of the first sealing member 107.

The poppet can include a flow metering orifice 108 that can have a cross-sectional open dimension (e.g., diameter) that is less than the corresponding cross-sectional dimension of the flow channel 113. The flow channel 113 and the flow metering orifice 108 can be configured to fluidly couple a portion of the flow chamber 110 upstream of at least a portion of the valve seat 114 and a portion of the flow chamber 110 downstream of at least a portion of the valve seat 114.

In the illustrated embodiments, the biasing member 105 is coupled between the housing 101 and the poppet 104 and can be configured to bias the poppet towards a first sealing member 107 (e.g., in the direction indicated by the arrow B in FIG. 1). The biasing member 105 can be or include a spring, such as a compression spring. In the illustrated embodiments, the housing 101 can include a stop portion 109 that can be positioned at least partially along the biasing member 105 (e.g., creating a channel/lumen around the biasing member 105). That is, the biasing member 105 can be coupled to and/or retained by the housing 101 at least partially within the stop portion 109. As shown in FIG. 2, the poppet 104 can abut/engage the stop portion 109 in the open position to inhibit or even prevent further compression of the biasing member 105. Accordingly, in the open position, the biasing member 105 may be positioned upstream and downstream of the stop portion 109. Additionally or alternatively, in the closed position, the biasing member 105 may be positioned downstream of the stop portion 109.

The various components of the check valve assembly 100 can be formed from metal, plastic, composite materials, and/or other suitably strong materials. Similarly, the components of the check valve assembly 100 can be manufactured via a molding process, three-dimensional printing process, and/or another suitable manufacturing process.

In the illustrated embodiments, a second sealing member 112 can be positioned between the poppet 104 and the housing 101 and configured to sealingly engage the poppet 104 to the housing 101 in all valve configurations (e.g., open, closed, or any position in between) to inhibit or even prevent the operating fluid 130 from bypassing the flow metering orifice 108 or first sealing member 107. As illustrated in FIGS. 1-3, the second sealing member 112 can be downstream of the first scaling member 107. Additionally or alternatively, the second sealing member 112 may have an inner radius that is greater than the inner radius of the first sealing member 107.

In some aspects of the present technology, the flow metering orifice 108 may have a cross-sectional open dimension (e.g., diameter) such that a given flow rate of the operating fluid 130 is established when the operating fluid 130 is delivered to the flow metering orifice 108 at a given inlet pressure. For example, with reference to FIG. 1, when the check valve assembly 100 is in the closed position, the biasing member 105 biases the poppet 104 toward the first sealing member 107 and the inlet port 102 such that the valve seat 114 and/or another portion of the poppet 104 sealingly engages the first sealing member 107 to inhibit or even prevent the operating fluid 130 from flowing into the flow chamber 110. Accordingly, the poppet 104 fluidly disconnects the inlet port 102 from the outlet port 106 in the closed position.

Referring to FIG. 2, when the force/pressure of the operating fluid 130 at the inlet port 102 exceeds a predetermined opening force/pressure (e.g., a “cracking pressure”) or threshold value, the operating fluid 130 forces the poppet 104 to move counter to the biasing force of the biasing member 105 (e.g., in the direction indicated by arrow C in FIG. 2) such that the poppet 104 disengages the first sealing member to permit the operating fluid 130 to flow through the flow chamber 110 from the inlet port 102 to the outlet port 106. Accordingly, the poppet 104 may not sealingly engage the first sealing member 107 in the open position, and the inlet port 102 is fluidly connected to the outlet port 106. In the illustrated embodiment, the operating fluid 130 flows (i) through the flow channel 113 in the poppet 104. In other embodiments, the poppet 104 can be configured differently to change the flow paths of the operating fluid 130. For example, the poppet 104 can be sized to generally match a dimension (e.g., circumference) of the flow chamber 110 to inhibit flow around the poppet 104 between the poppet 104 and the housing 101. Likewise, the flow channel 113 can be omitted such that the only flow path is around the poppet 104. In some embodiments, the biasing member 105 can be selected to provide a predetermined cracking pressure. For example, a spring constant of the biasing member 105 can be selected/tuned to provide a higher or lower cracking pressure

Referring to FIG. 2, if the force/pressure of the operating fluid 130 exceeds a predetermined stop force/pressure, the operating fluid 130 can drive the poppet 104 into engagement with the stop portion 109 of the housing 101 to inhibit further compression of the biasing member 105. Accordingly, in the open position, the stop portion 109 prevents the poppet 104 from moving farther from and/or downstream of the first sealing member 107 of the housing 101 in the direction indicated by the arrow C in FIG. 2. In the illustrated embodiment, the poppet 104 abuts the stop portion 109 before the biasing member 105 is fully compressed (e.g., reaches a solid-height position in which adjacent coils of the biasing member 105 all contact one another). In some aspects of the present technology, the stop portion 109 can inhibit excessive compression of the biasing member 105 that could damage the biasing member 105.

Referring back to FIGS. 1 and 2, moving the poppet 104 between the closed and open positions drives against the force of biasing member 105. The inlet pressure of the operating fluid 130 is decreased as it flows through the flow metering orifice 108. The decrease in inlet pressure at the flow metering orifice 108 results in a force on the poppet 104 in the direction indicated by arrow C in FIG. 2 which acts to counter the force of the biasing member 105. In some embodiments, the cross-sectional open dimension (e.g., diameter) of the flow metering orifice 108 can be selected to provide a target amount of force opposing the biasing member 105 at a specific inlet pressure. For example, the flow metering orifice 108 can be made relatively smaller to provide a greater amount of force such that the poppet 104 abuts/engages the stop portion 109 at lower inlet pressures or flow rates, thereby reducing the range of inlet pressures which results in the rapid opening and closing (“chattering”) of the check valve assembly 100.

In various aspects of the present technology, the check valve assembly 100 can reduce the movement of the poppet 104 even when the pressure of the operating fluid 130 at the inlet port 102 rapidly oscillates/fluctuates. This can inhibit or even prevent the check valve assembly 100 from rapidly opening and closing (“chattering”), thereby reducing the wear on the housing 101, the first sealing member 107, the second sealing member 112, the biasing member 105, and/or the poppet 104, and/or other components of the check valve assembly 100. In contrast, conventional check valves are susceptible to chatter when the inlet pressure rapidly fluctuates.

In several aspects of the present technology, the check valve assembly 100 can reduce the movement of the poppet 104 even when the pressure of the operating fluid 130 at the inlet port 102 is small. Additionally or alternatively, a reduction of pressure by the flow metering orifice 108 may inhibit movement of the poppet 104. This can inhibit or even prevent the check valve assembly 100 from oscillating in the partially open position, thereby reducing the wear on the housing 101, the first sealing member 107, the second sealing member 112, the biasing member 105, and/or the poppet 104, and/or other internal components of the check valve assembly 100. In contrast, conventional check valve assemblies are susceptible to oscillating in the partially open position when the inlet pressure is insufficient to overcome the biasing member 105.

With further reference to FIG. 3, in some embodiments, the check valve assembly 100 can be installed into and/or onto a supply line of the operating fluid 130 that can experience pressurized backflow (e.g., pressurized flow in the direction of arrow D in FIG. 3). Under such conditions, the poppet 104 can engage the housing to inhibit the operating fluid 130 from flowing from the outlet port 106 to the inlet port 102. Moreover, as shown in FIG. 3, the operating fluid 130 may flow through the flow channel 113 (and the flow metering orifice 108), and however be inhibited from flowing to the inlet port by the first sealing member 107.

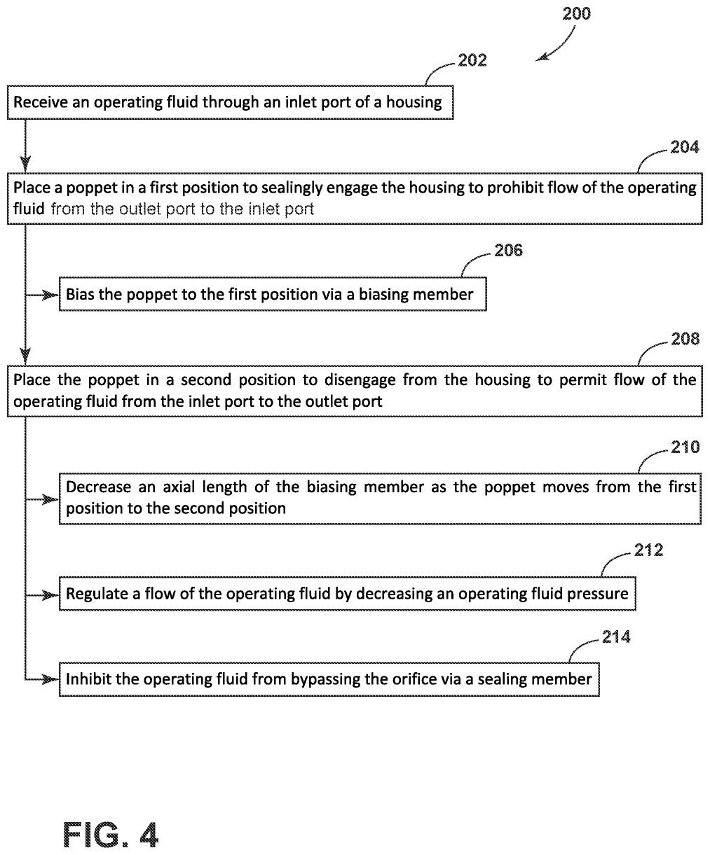

Referring now to FIG. 4, a flow diagram of some embodiments of a method for operating a check valve assembly is illustrated in accordance with aspects of the present subject matter. In general, the method 200 will be described herein with reference to the check valve assembly described above with reference to FIGS. 1-3. However, the method 200 may generally be utilized with any suitable valve assembly and/or may be utilized in connection with a system having any other suitable configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As illustrated in FIG. 4, at (202), the method may include receiving an operating fluid through an inlet port of a housing. The housing further defines an outlet port and a flow chamber defined by the housing and fluidly coupling the inlet port to the outlet port.

At (204), the method 200 may include placing a poppet in a first position to sealingly engage the housing to prohibit the flow of the operating fluid from the outer port to the inlet port. As provided herein, the poppet defines a flow chamber fluidly coupling the inlet port to the outlet port and a flow metering orifice positioned in the flow chamber.

At (206), the method may include biasing the poppet to the first position via a biasing member. In some cases, the biasing member is retained between a stop defined by the housing and the poppet.

At (208), the method 200 may include placing the poppet in a second position to disengage from the housing to permit flow of the operating fluid from the inlet port to the outlet port. In some embodiments, when the poppet moves between the first and second positions, the inlet pressure of the operating fluid is decreased as the operating fluid flows through the flow metering orifice to reduce movement of the poppet.

At (210), the method 200 may include decreasing an axial length of the biasing member as the poppet moves from the first position to the second position. In some embodiments, at (212), the method 200 may include regulating a flow of the operating fluid by decreasing an operating fluid pressure. At (214), the method 200 may include inhibiting the operating fluid from bypassing the flow metering orifice via a sealing member.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A check valve assembly, comprising:
a housing comprising an inlet port, an outlet port, and a flow chamber defined by the housing and fluidly coupling the inlet port to the outlet port;
a poppet assembly movable between a closed position and an open position, the poppet assembly comprising a poppet positioned in the flow chamber and configured to sealingly engage the housing in the closed position to fluidly disconnect the inlet port from the outlet port, the poppet defining a flow channel and a flow metering orifice positioned in the flow channel; and
a biasing member operably coupled to the poppet, wherein the biasing member is configured to bias the poppet assembly to the closed position.

2. The check valve assembly of claim 1, wherein the inlet port is configured to receive a flow of an operating fluid.

3. The check valve assembly of claim 2, wherein the poppet assembly is configured to move from the closed position to the open position when a pressure of the operating fluid at the inlet port exceeds a threshold value.

4. The check valve assembly of claim 3, wherein the poppet disengages the housing to permit the operating fluid to flow from the inlet port to the outlet port when the poppet assembly is in the open position.

5. The check valve assembly of claim 2, wherein the housing further comprises:
a first sealing member between the poppet and the housing configured to fluidly disconnect the flow from the inlet port to the outlet port.

6. The check valve assembly of claim 5, wherein the housing further comprises:
a second sealing member positioned between the poppet and the housing configured to inhibit the operating fluid from bypassing the flow metering orifice or the first sealing member.

7. The check valve assembly of claim 1, wherein the housing includes a central section and outer section, and wherein the flow chamber is defined between the central section of the housing and the outer section of the housing.

8. The check valve assembly of claim 7, wherein the housing further defines a protrusion radially aligned with at least a portion of the central section of the housing.

9. A check valve assembly comprising:
a housing comprising an inlet port, an outlet port, and a flow chamber defined by the housing and fluidly coupling the inlet port to the outlet port;
a poppet assembly movable between a closed position and an open position, the poppet assembly comprising a poppet positioned in the flow chamber and configured to sealingly engage the housing in the closed position to fluidly disconnect the inlet port from the outlet port, the poppet assembly further comprising a flow metering orifice positioned in a flow channel; and
a biasing member operably coupled to the poppet and configured to bias the poppet assembly to the closed position.

10. The check valve assembly of claim 9, wherein, when the poppet moves between the closed position and the open position, an inlet pressure of the operating fluid is decreased as the operating fluid flows through the flow metering orifice to reduce movement of the poppet.

11. The check valve assembly of claim 9, wherein the biasing member is configured to bias the poppet to the closed position.

12. The check valve assembly of claim 9, wherein a decrease in an operating fluid pressure regulates the flow of the operating fluid.

13. The check valve assembly of claim 9, wherein a reduction of pressure by the flow metering orifice inhibits movement of the poppet.

14. A method for operating a check valve assembly, the method comprising:
receiving an operating fluid through an inlet port of a housing, the housing further defining an outlet port;
placing a poppet in a first position to sealingly engage the housing to prohibit flow of the operating fluid from the outlet port to the inlet port, the poppet defining a flow chamber fluidly coupling the inlet port to the outlet port and a flow metering orifice positioned in the flow chamber; and
placing the poppet in a second position to disengage from the housing to permit flow of the operating fluid from the inlet port to the outlet port, wherein, when the poppet moves between the first position and the second position, an inlet pressure of the operating fluid is decreased as the operating fluid flows through the flow metering orifice to reduce movement of the poppet.

15. The method of claim 14, further comprising:
biasing, via a biasing member, the poppet to the first position.

16. The method of claim 15, wherein the biasing member is retained between a stop defined by the housing and the poppet.

17. The method of claim 15, further comprising:
decreasing an axial length of the biasing member as the poppet moves from the first position to the second position.

18. The check valve assembly of claim 14,
regulating the flow of the operating fluid by decreasing an operating fluid pressure.

19. The check valve assembly of claim 14,
inhibiting movement of the poppet by reducing an operating fluid pressure within the flow metering orifice.

20. The check valve assembly of claim 14,
inhibiting, via a scaling member, the operating fluid from bypassing the flow metering orifice.
